(19) United States
(12) Patent Application Publication
(10) Pub. No.: US 2014/0337077 A1
(43) Pub. Date: Nov. 13, 2014

(54) TASK ASSIGNMENT AND VERIFICATION SYSTEM AND METHOD

(71) Applicant: VoloForce, LLC, Germantown, MD (US)

(72) Inventors: PAUL ZSEBEDICS, Daenestown, MD (US); SAMUEL S. BAHREINI, Clarksburg, MD (US)

(73) Assignee: VoloForce, LLC, Germantown, MD (US)

(21) Appl. No.: 14/269,425

(22) Filed: May 5, 2014

Related U.S. Application Data
(60) Provisional application No. 61/820,800, filed on May 8, 2013.

(51) Int. Cl. G06Q 10/06

(52) U.S. Cl. CPC G06Q 10/063114
USPC 705/7.15

(57) ABSTRACT

A method, computer program product, and computer system for determining, at a first computing device, an occurrence of an event. A task associated with the event to be completed is sent based upon, at least in part, the occurrence of the event. Information to verify that the task associated with the event is complete is received from a second computing device. The task associated with the event is identified as complete based upon, at least in part, the information.

### RELATED CASES

This application claims the benefit of U.S. Provisional Application No. 61/820,800 filed on 8 May 2013, by Zsebedics et al., the contents of which are all incorporated by reference.

### BACKGROUND

Managing tasks across many different locations may be onerous and difficult, as it may require that someone physically be at each location to verify the task was completed and completed correctly. For example, company X may have 10 store locations around a particular geographic area. In the example, company X may assign a task to have a particular display area of products set up in a particular way by a particular date and time. In some instances, someone may be required to physically visit each of the 10 stores to verify whether the display area was set up as instructed.

### BRIEF SUMMARY OF DISCLOSURE

In one implementation, a method, performed by one or more computing devices, may comprise determining, at a first computing device, an occurrence of an event. A task associated with the event to be completed is sent based upon, at least in part, the occurrence of the event. Information to verify that the task associated with the event is complete is received from a second computing device. The task associated with the event is identified as complete based upon, at least in part, the information.

One or more of the following features may be included. Determining the occurrence of the event may include receiving a serialized data feed associated with the event. The information may include at least one of an image, a video, a voice, a text, and a numeric value. The information may include at least one of a time when the task associated with the event is complete and a location of where the task associated with the event is complete. Sending the task associated with the event may include sending at least one of a description of the task and an image of the task. Identifying the task associated with the event as complete may include performing comparative analysis with the information. A request to generate a visual representation of one or more previously completed tasks may be received.

In another implementation, a computing system includes a processor and a memory configured to perform operations that may comprise determining, at a first computing device, an occurrence of an event. A task associated with the event to be completed is sent based upon, at least in part, the occurrence of the event. Information to verify that the task associated with the event is complete is received from a second computing device. The task associated with the event is identified as complete based upon, at least in part, the information.

One or more of the following features may be included. Determining the occurrence of the event may include receiving a serialized data feed associated with the event. The information may include at least one of an image, a video, a voice, a text, and a numeric value. The information may include at least one of a time when the task associated with the event is complete and a location of where the task associated with the event is complete. Sending the task associated with the event may include sending at least one of a description of the task and an image of the task. Identifying the task associated with the event as complete may include performing comparative analysis with the information. A request to generate a visual representation of one or more previously completed tasks may be received.

In another implementation, a computer program product resides on a computer readable storage medium that has a plurality of instructions stored on it. When executed by a processor, the instructions cause the processor to perform operations that may comprise determining, at a first computing device, an occurrence of an event. A task associated with the event to be completed is sent based upon, at least in part, the occurrence of the event. Information to verify that the task associated with the event is complete is received from a second computing device. The task associated with the event is identified as complete based upon, at least in part, the information.

One or more of the following features may be included. Determining the occurrence of the event may include receiving a serialized data feed associated with the event. The information may include at least one of an image, a video, a voice, a text, and a numeric value. The information may include at least one of a time when the task associated with the event is complete and a location of where the task associated with the event is complete. Sending the task associated with the event may include sending at least one of a description of the task and an image of the task. Identifying the task associated with the event as complete may include performing comparative analysis with the information. A request to generate a visual representation of one or more previously completed tasks may be received.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is an illustrative diagrammatic view of a task process coupled to a distributed computing network according to one or more implementations of the present disclosure;

FIG. 2 is a diagrammatic view of a client electronic device of FIG. 1 according to one or more implementations of the present disclosure;

FIG. 3 is an illustrative flowchart of the task process of FIG. 1 according to one or more implementations of the present disclosure;

FIG. 4 is an illustrative diagrammatic view of a screen image displayed by the task process of FIG. 1 according to one or more implementations of the present disclosure;

FIG. 5 is an illustrative diagrammatic view of a screen image displayed by the task process of FIG. 1 according to one or more implementations of the present disclosure;

FIG. 6 is an illustrative diagrammatic view of a screen image displayed by the task process of FIG. 1 according to one or more implementations of the present disclosure; and

FIG. 7 as needed according to one or more implementations of the present disclosure.

Like reference symbols in the various drawings indicate like elements.

### DETAILED DESCRIPTION

### System Overview:

As will be appreciated by one skilled in the art, the present disclosure may be embodied as a method, system, or computer program product. Accordingly, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of this document, a computer-usable or computer-readable, storage medium may be any tangible medium that can contain or store a program for use by or in connection with the instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. The computer readable program code may be transmitted using any appropriate medium, including but not limited to the internet, wireline, optical fiber cable, RF, etc. A computer readable signal medium may be any computer readable medium that is not a computer readable storage medium and that can communicate, propagate, or transport a program for use by or in connection with an instruction execution system, apparatus, or device.

Computer program code for carrying out operations of the present disclosure may be written in an object oriented programming language such as Java®, Smalltalk, C++ or the like. Java and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript or PERL. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider).

The flowchart and block diagrams in the figures illustrate the architecture, functionality, and operation of possible implementations of apparatus (systems), methods and computer program products according to various implementations of the present disclosure. It will be understood that each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some alternative implementations, the functions noted in the block(s) may occur out of the order noted in the figures. For example, two blocks shown in succession may, in fact, be executed substantially concurrently, or the blocks may sometimes be executed in the reverse order, depending upon the functionality involved.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

The computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

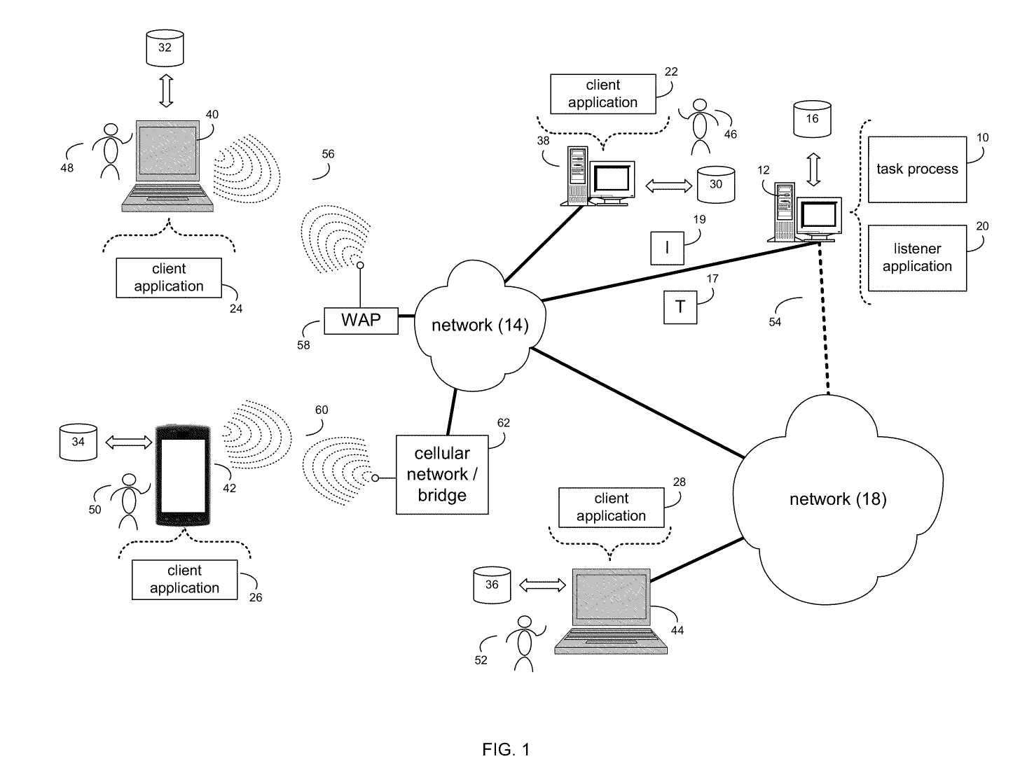

Referring to FIG. 1, there is shown task process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a personal computer(s), a laptop computer(s), mobile computing device(s), a server computer, a series of server computers, a mainframe computer(s), or a computing cloud(s). Computer 12 may execute an operating system, for example, but not limited to, Microsoft® Windows®; Mac® OS X®; Red Hat® Linux®, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

As will be discussed below in greater detail, task process 10 may determine, at a first computing device, an occurrence of an event. A task (e.g., task 17) associated with the event to be completed may be sent based upon, at least in part, the occurrence of the event. Information (e.g., information 19) to verify that the task associated with the event is complete may be received from a second computing device. The task associated with the event may be identified as complete based upon, at least in part, the information.

The instruction sets and subroutines of task process 10, which may be stored on storage device 16 coupled to computer 12, may be executed by one or more processors (not shown) and one or more memory architectures (not shown) included within computer 12. Storage device 16 may include but is not limited to: a hard disk drive; a flash drive, a tape drive; an optical drive; a RAID array; a random access memory (RAM); and a read-only memory (ROM).

Network 14 may be connected to one or more secondary networks (e.g., network 18), examples of which may include but are not limited to: a local area network; a wide area network; or an intranet, for example.

Computer 12 may include a data store, such as a database (e.g., relational database, object-oriented database, triplestore database, etc.) and may be located within any suitable memory location, such as storage device 16 coupled to computer 12. Any data described throughout the present disclosure may be stored in the data store. In some implementations, computer 12 may utilize a database management system such as, but not limited to, (MySQL®) in order to provide multi-user access to one or more databases, such as the above noted relational database. The data store may also be a custom database, such as, for example, a flat file database or an XML database. Any other form(s) of a data storage structure and/or organization may also be used. Task process 10 may be a component of the data store, a stand alone application that interfaces with the above noted data store and/or an applet/application that is accessed via client applications 22, 24, 26, 28. The above noted data store may be, in whole or in part, distributed in a cloud computing topology. In this way, computer 12 and storage device 16 may refer to multiple devices, which may also be distributed throughout the network.

Computer 12 may execute a listener application (e.g., listener application 20), examples of which may include, but are not limited to, e.g., a web feed (e.g., serialized data feed/RSS feed, etc.) application, image comparison application, such as, e.g., keypoint matching, histogram method, keypoints and decision trees, etc., a digital/analog switch/counter, or other application that allows for the identification of a condition. In some implementations, trigger points and protocols for the conditions may be entered manually. Task process 10 and/or listener application 20 may be accessed via client applications 22, 24, 26, 28. Task process 10 may be a stand alone application, or may be an applet/application/script that may interact with and/or be executed within listener application 20 and/or one or more of client applications 22, 24, 26, 28. Listener application 20 may be a stand alone application, or may be an applet/application/script that may interact with and/or be executed within task process 10 and/or one or more of client applications 22, 24, 26, 28. One or more of client applications 22, 24, 26, 28 may be a stand alone application, or may be an applet/application/script that may interact with and/or be executed within task process 10 and/or listener application 20. Examples of client applications 22, 24, 26, 28 may include, but are not limited to, e.g., a web feed (e.g., serialized data feed) application, image comparison application, such as, e.g., keypoint matching, histogram method, keypoints and decision trees, etc., a digital/analog switch/counter, or other application that allows for the identification of a condition, a standard and/or mobile web browser, an email client application, a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36 coupled to client electronic devices 38, 40, 42, 44, may be executed by one or more processors (not shown) and one or more memory architectures (not shown) incorporated into client electronic devices 38, 40, 42, 44.

Storage devices 30, 32, 34, 36 may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet (not shown), a server (not shown), a television (not shown), a smart television (not shown), a media (e.g., video, photo, etc.) capturing device (not shown), and a dedicated network device (not shown). Client electronic devices 38, 40, 42, 44 may each execute an operating system, examples of which may include but are not limited to, Android™, Apple® iOS®, Mac® OS X®; Red Hat® Linux®, or a custom operating system.

One or more of client applications 22, 24, 26, 28 may be configured to effectuate some or all of the functionality of task process 10 (and vice versa). Accordingly, task process 10 may be a purely server-side application, a purely client-side application, or a hybrid server-side/client-side application that is cooperatively executed by one or more of client applications 22, 24, 26, 28 and/or task process 10.

One or more of client applications 22, 24, 26, 28 may be configured to effectuate some or all of the functionality of listener application 20 (and vice versa). Accordingly, listener application 20 may be a purely server-side application, a purely client-side application, or a hybrid server-side/client-side application that is cooperatively executed by one or more of client applications 22, 24, 26, 28 and/or listener application 20. As one or more of client applications 22, 24, 26, 28, task process 10, and listener application 20, taken singly or in any combination, may effectuate some or all of the same functionality, any description of effectuating such functionality via one or more of client applications 22, 24, 26, 28, task process 10, listener application 20, or combination thereof, and any described interaction(s) between one or more of client applications 22, 24, 26, 28, task process 10, listener application 20, or combination thereof to effectuate such functionality, should be taken as an example only and not to limit the scope of the disclosure.

Users 46, 48, 50, 52 may access computer 12 and task process 10 (e.g., using one or more of client electronic devices 38, 40, 42, 44) directly through network 14 or through secondary network 18. Further, computer 12 may be connected to network 14 through secondary network 18, as illustrated with phantom link line 54. Task process 10 may include one or more user interfaces, such as browsers and textual or graphical user interfaces, through which users 46, 48, 50, 52 may access task process 10.

The various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, Wi-Fi®, and/or Bluetooth™ device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown directly coupled to network 14.

Some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

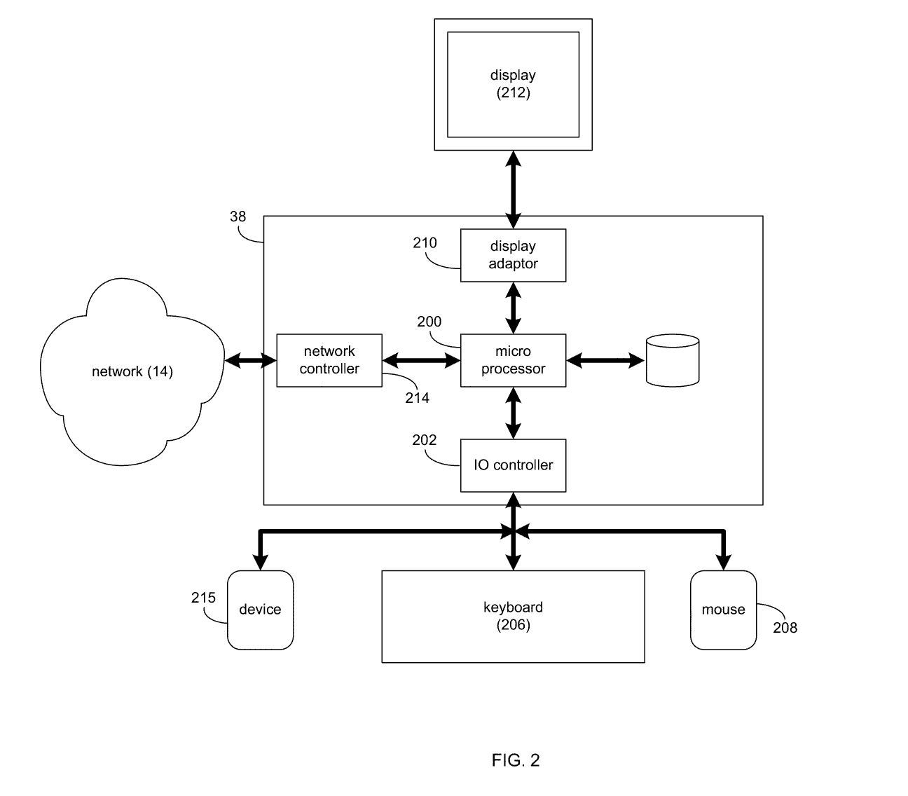

Referring also to FIG. 2, there is shown a diagrammatic view of client electronic device 38. While client electronic device 38 is shown in this figure, this is for illustrative purposes only and is not intended to be a limitation of this disclosure, as other configurations are possible. For example, any computing device capable of executing, in whole or in part, task process 10 may be substituted for client electronic device 38 within FIG. 2, examples of which may include but are not limited to computer 12 and/or client electronic devices 40, 42, 44.

Client electronic device 38 may include a processor and/or microprocessor (e.g., microprocessor 200) configured to, e.g., process data and execute the above-noted code/instruction sets and subroutines. Microprocessor 200 may be coupled via a storage adaptor (not shown) to the above-noted storage device. An I/O controller (e.g., I/O controller 202) may be configured to couple microprocessor 200 with various devices, such as keyboard 206, pointing/selecting device (e.g., mouse 208), custom device (e.g., device 215), USB ports (not shown), and printer ports (not shown). A display adaptor (e.g., display adaptor 210) may be configured to couple display 212 (e.g., CRT or LCD monitor(s)) with microprocessor 200, while network controller/adaptor 214 (e.g., an Ethernet adaptor) may be configured to couple microprocessor 200 to the above-noted network 14 (e.g., the Internet or a local area network).

The Task Process:

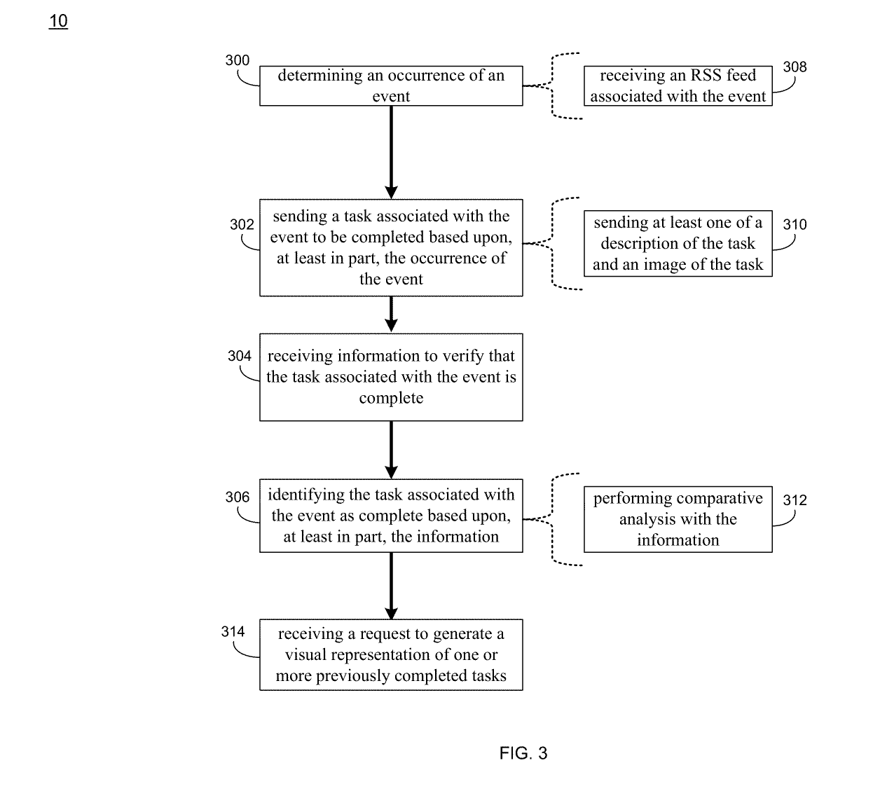

As discussed above and referring also to FIGS. 3-7, task process 10 may determine 300, at a first computing device, an occurrence of an event. A task associated with the event to be completed may be sent 302 by task process 10 based upon, at least in part, the occurrence of the event. Information to verify that the task associated with the event is complete may be received 304 by task process 10 from a second computing device. The task associated with the event may be identified 306 by task process 10 as complete based upon, at least in part, the information.

In some implementations, task process 10 may determine 300, at a first computing device (e.g., computer 12), an occurrence of an event. For instance, assume for example purposes only that a company (e.g., company X) has 10 store locations. In the example, company X may require that when a particular event occurs (e.g., rain), each store location associated with the event (e.g., each store location where it is raining) must put out rain mats. In some implementations, determining 300 the occurrence of the event may include task process 10 receiving 308 a serialized data feed associated with the event. For example, task process 10 may receive 308 a weather related serialized data feed that indicates 3 of the 10 store locations (store A, store B, and store C) are in an area where it is (and/or will be) raining. In response to receiving 308 the serialized data feed, task process 10 may determine 300 that the event (e.g., rain) is (and/or will be) occurring at locations for store A, store B, and store C.

While the above description of an event may include weather/environmental related events (e.g., rain, snow, etc.), other examples of events may also be included without departing from the scope of the disclosure. For instance, an event may include a threshold number of customers entering/leaving one or more stores as determined by, e.g., a traffic counter associated with listener application 20. As another example, an event may include predetermined and/or random time intervals, chains of responsibility, and manual updates. As such, the use of a weather related event should be taken as an example only and not to limit the scope of the present disclosure.

In some implementations, listener application 20 may listen to more than a single source to verify a primary source for accuracy. For example, a thermal counter (associated with listener application 20) at a point of egress may count people coming in and/or out. To make the count more accurate, task process 10 and/or listener application 20 may listen for additional inputs to verify the number and “true it up”. For instance, the thermal counter at the entrance door may have an analog or digital switch, and if people walk under the thermal sensor and the switch on the door did not open, the additional targets may not be counted as a valid count. In some implementations, task process 10 and/or listener application 20 may listen may look for additional sensors, such as a radio frequency on a proximity reader (associated with listener application 20), to exclude or include employees coming in and out of the location for example. Task process 10 and/or listener application 20 may thus compile multiple data points to provide an accurate count.

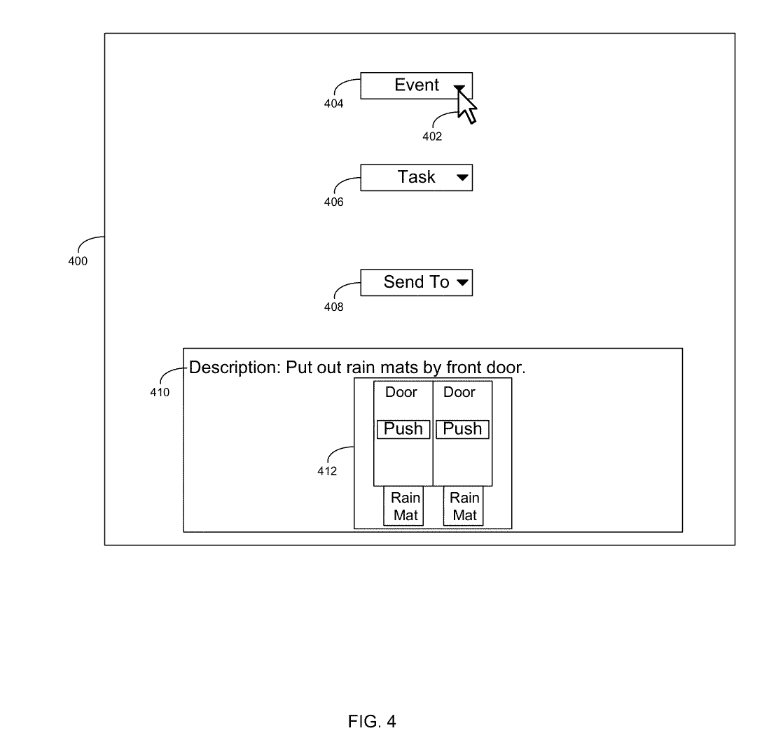

In some implementations, a task (e.g., task 17) associated with the event to be completed may be sent 302 by task process 10 based upon, at least in part, the occurrence of the event. For example, and referring at least to FIG. 4, a user interface (e.g., UI 400) may be associated with task process 10, listener application 20, one or more of the above-noted client applications, or combination thereof. A user (e.g., user 46) may, e.g., via task process 10, utilize UI 400 to, e.g., create a task based on an event. For example, user 46, who may be a regional store manager for company X, may use cursor 402 via a pointing device (e.g., mouse 208) to select object 404 to select which event (e.g., rain) to associate with task 17. Similarly, user 46 may use cursor 402 to select object 406 to select the particular task to be associated with the event, such as having a particular worker at one or more of the stores put out a rain mat. In some implementations, user 46 may use cursor 402 to select object 408 to select an action of what should be done in response to the event (e.g., where task 17 that is associated with the event should be sent), such as one or more of the stores associated with the event (e.g., where task process 10 determines 300 that the event (e.g., rain) is (and/or will be) occurring, such as locations for store A, store B, and store C in the above example).

In some implementations, sending 302 the task associated with the event may include task process 10 sending 310 at least one of a description of the task and an image of the task. For example, UI 400 may enable user 46 to enter description 410 that may provide more detail about task 17, such as where the rain mats should be put out. UI 400 may also enable user 46 to upload media, such as video and/or an image (e.g., image 412) that may provide visual detail about task 17. In some implementations, image 412 may include, e.g., a visual representations of a store's products and/or services, such as a planogram or schematic.

While the above-description may include the task of putting out rain mats, it will be appreciated that other examples of tasks associated with other examples of events may be used without departing from the scope of the present disclosure. For example, task process 10 may determine 300 (e.g., via listener application 20) that 150 customers have walked into store A (e.g., within a predetermined period of time). In response, task process 10 may send 302 to store A the task of, e.g., cleaning the glass door, cleaning the bathroom, emptying the garbage, etc.). As another example, the task may include the particular way that a product display should be setup in a store by a set time. In some implementations, task process 10 may send 302 task 17 automatically upon determining 300 the occurrence of the event, and/or may be sent 300 manually by user 46, e.g., via one or more customizable options (not shown) in UI 400. In some implementations, the tasks may be associated with zones and sections in a particular location. For instance, the entrance at store A may be considered a zone, and within that zone, there may be one or more sections for, e.g., POS or brochures. As another example, an aisle in store A may be a zone, and within that zone may be one or more shelves, with one or more of the shelves being a section. In the example, the task may be associated with the zone and/or section. As such, the task of putting out rain mats, as well as tasks being associated with a particular location, zone and/or section within a zone, should be taken as an example only and not to limit the scope of the present disclosure.

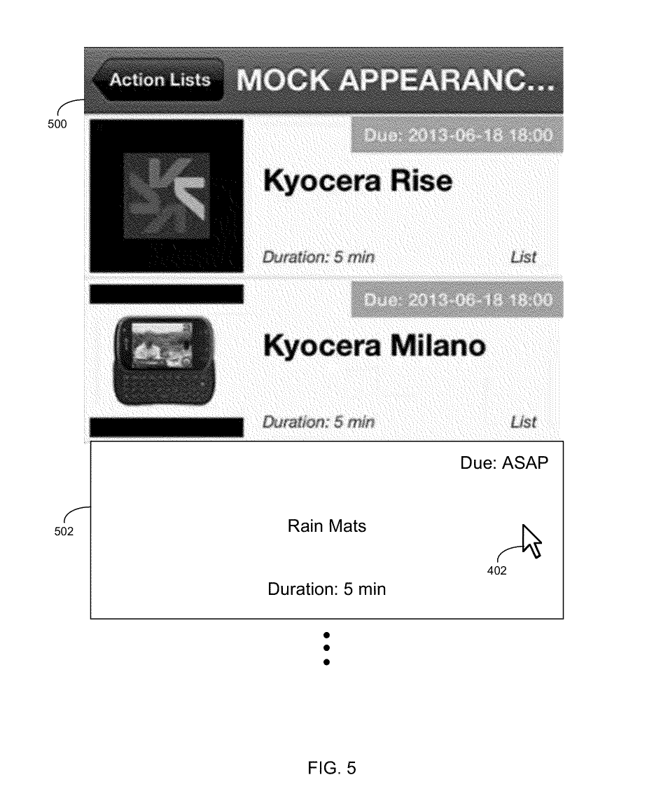

In some implementations, information (e.g., information 19) to verify that the task associated with the event is complete may be received 304 by task process 10 from a second computing device (e.g., via client electronic device 44). For instance, and referring at least to FIG. 5, task process 10 (e.g., via client application 28) may generate a user interface “dashboard” (e.g., dashboard 500) of one or more tasks currently assigned and sent 302 to a store (e.g., store A). Dashboard 500 may be accessed, e.g., via client application 28 and client electronic device 44, by a user (e.g., user 52), who may be an employee of store A, such that user 52 may view each currently assigned task. For example, user 52 may (via client application 28) use cursor 402 to select the above-noted task of putting out rain mats.

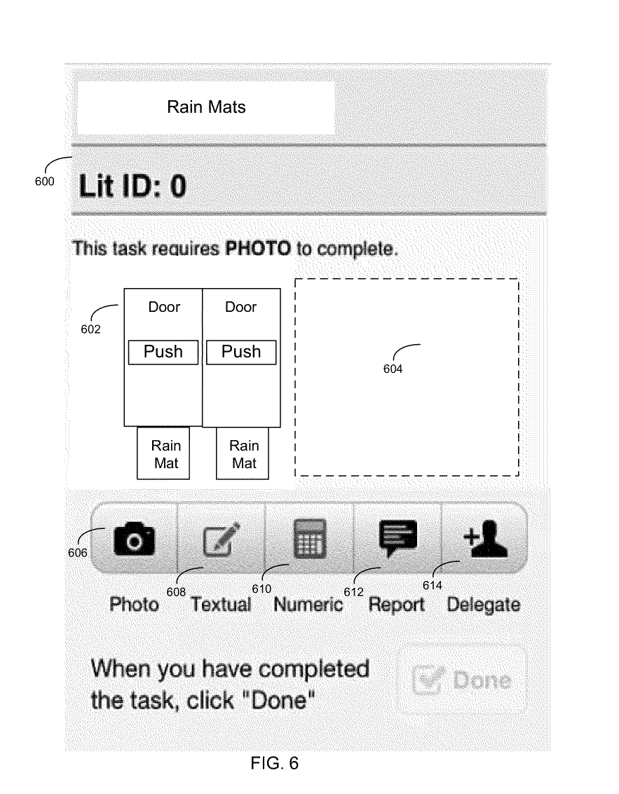

In some implementations, information 19 may include at least one of an image, a video, a voice, a text, and a numeric value. For example, and referring at least to FIG. 6, assume that user 52 has selected the rain mats task 502 from dashboard 500. In response, task process 10 (e.g., via client application 28) may render a user interface (e.g., UI 600) that may enable user 52 to send proof that the task of putting out the rain mat was adequately completed, which may be received 304 by task process 10. For instance, UI 600 may include, e.g., the above-noted description 410 and/or image 412 (shown as image 602) of the example task of putting out rain mats. UI 600 may also include an area (e.g., area 604) where user 52 may upload and/or enter proof (e.g., information 19) of the completed task. For example, UI 600 may enable user 52 to select an object (e.g., object 606) to capture and/or upload media (e.g., an image and/or video) of the completed task by utilizing, e.g., a camera application/hardware associated with client electronic device 44 and/or client application 28. Further in the example, video of the task being completed may begin being captured at the start of the task (e.g., via selection of objected 606), and may end upon completion of the task. Further in the example, selecting object 606 may cause the device capturing the video to pan/tilt/zoom, etc. to the particular location (e.g., zone, section, etc.) where the task is to be completed. Live video of any particular location may be switched to/from the captured media. As another example, UI 600 may enable user 52 to select an object (e.g., object 608) to enter text associated with the completed task (e.g., “I am verifying that I completed the task of putting out the rain mats as described”). As another example, UI 600 may enable user 52 to select an object (e.g., object 610) to enter text (e.g., one or more numeric values) associated with the completed task. As another example, UI 600 may enable user 52 to select an object (e.g., object 612) to send a report associated with the completed task. In some implementations, UI 600 may enable user 52 to select an object (e.g., object 614) to delegate the task to one or more other employees, e.g., of store A.

In some implementations, information 19 may include at least one of a time when the task associated with the event is complete and a location of where the task associated with the event is complete. For example, the above-noted image that may have been uploaded in area 604 may include a timestamp and/or may include location information provided by, e.g., GPS capabilities that may be associated with client electronic device 44 and client application 28. Continuing with the above-example, assuming for example purposes only that user 52 captured the above-noted image as proof at 3:00 PM, the image may include a timestamp of 3:00 PM and/or a location of where the image was taken (e.g., “store A”, “Boston, Mass. 02127”, etc.), which may be useful in preventing fraudulent claims of having completed the task. For instance, use of the timestamp and location may help prevent user 52 from reusing the same image every time there is a task to put out rain mats, and may also prevent user 52 from using a similar image taken at another store location (e.g., store B) to make it appear as if it were taken at store A. In some implementations, information 19 may be captured and/or sent to task process 10 by, e.g., a PTZ or security camera within store A, which may automatically apply a timestamp and location information. In the example, user 52 may, but need not be, required to send information 19 to be received 304 by task process 10. For instance, a security camera in store A that may have a view of the location where the rain mats are to be placed may periodically capture and/or send to computer 12 a before and/or after image of the location where the rain mats are to be placed.

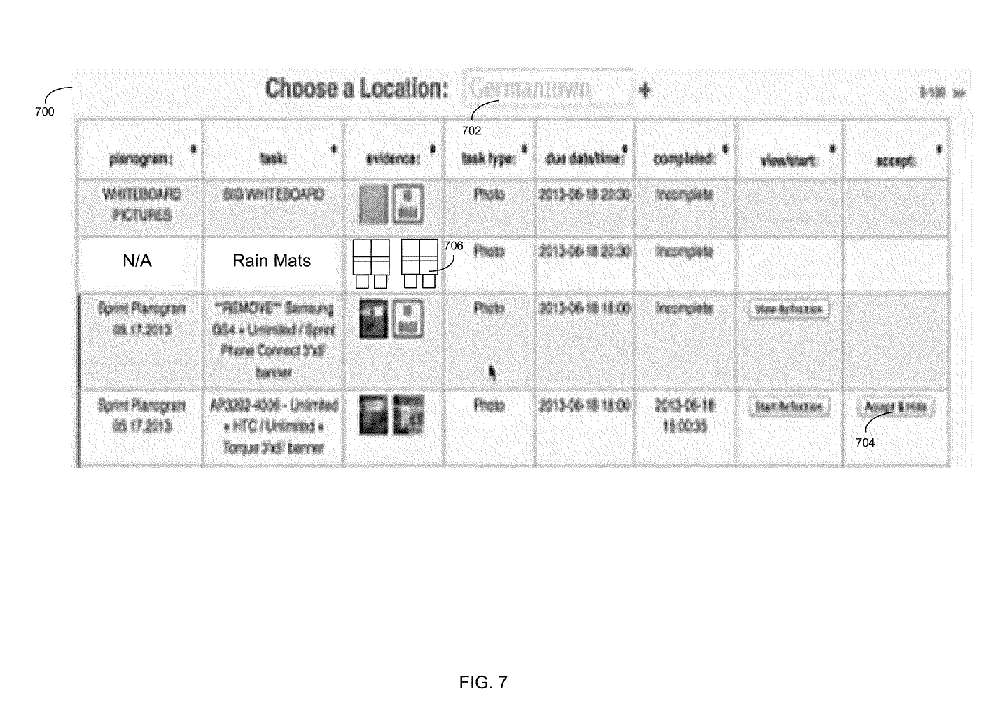

In some implementations, the task associated with the event may be identified 306 by task process 10 as complete based upon, at least in part, the information. For example, and referring at least to FIG. 7, a user interface dashboard (e.g., dashboard 700) associated with task process 10 may be accessible to, e.g., user 46. Dashboard 700 may include, e.g., a spreadsheet setup, which may display data associated with one or more assigned tasks. For instance, data may include a description of the task, the evidence (e.g., information 19) submitted by user 52 and received 304 to verify the task was adequately completed and/or completed on time, the task type, the due date of the task, as well as other data. For instance, if a task has been assigned, whether the task is in process, completed, failed, or needs more information to determine completion/failure. In some implementations, dashboard 700 may enable user 52 to sort and/or organize tasks according to location (e.g., store location, region, etc.) using, e.g., search box 702. Other sorting criteria may also be used, such as, e.g., pendency of assigned tasks, completed tasks, non-completed tasks, importance of task, etc. In some implementations, identifying 306 the task associated with the event as complete may include task process 10 performing 312 comparative analysis with information 19. For instance, assume for example purposes only that user 52 (via client application 28) has submitted evidence (e.g., information 19) in the form of an image for having completed the task of putting out rain mats. In the example, when the image is received 304 at, e.g., computer 12, comparative analysis may be performed 312 by task process 10 using known comparative algorithms. Further in the example, if the image received 304 at computer 12 is determined by task process 10 to inadequately match the above-noted image 412 (e.g., within a predetermined threshold), task process 10 may automatically deny and/or reject the task as having been completed. In some implementations, a notice (e.g., email, text, voice message, etc.) may be automatically generated and/or sent by task process 10 to user 52. In some implementations, the notice may be sent manually (e.g., by user 46 via task process 10). The notice may include a message that, e.g., the task was not adequately completed and must be redone and resubmitted for approval. In some implementations, if the image received 304 at computer 12 is determined by task process 10 to adequately match the above-noted image 412 (e.g., within a predetermined threshold), task process 10 may automatically identify 306 and accept the task as having been completed. In some implementations, identifying 306 the task as having been completed may cause task process 10 to “hide” the task from dashboard 700, cross out the task from dashboard 700, highlight the task in dashboard 700, or apply any other characteristics to the task in dashboard 700 to visually identify 306 the task as complete.

In some implementations, a request to generate a visual representation of one or more previously completed tasks may be received 314 by task process 10. For example, user 46 may use the above-noted cursor to select an object (e.g., object 706) representing the image received 304 at computer 12. Selecting object 706 may generate a request received 314 by task process 10, which may cause the image (e.g., included with information 19) and/or image 412 to be generated by task process 10 (e.g., side by side and/or individually). This may enable user 46 to personally view/compare the adequacy of the task completion. In the example, user 46 may manually accept a task as having been completed by using the cursor to select an “accept task” object, such as object 704.

While the above description refers to management of retail stores, it will be appreciated that other uses are possible without departing from the scope of the present disclosure. For instance, task process 10 may be used in facility management to inform and prove that a task was completed and keep records of such. As another example, in equipment rental, when a component is returned to the owner, the owner may be assigned the task of taking a picture of the returned equipment to log the equipment received, which may be used to build a histogram of the condition of the equipment to see when damages where created. As such, the use of retail stores should be taken as an example only and not to limit the scope of the present disclosure.

In some implementations, task process 10 may analyze the performance of the individuals (e.g., user 52) based upon the information received 304 from one or more previously completed tasks. For example, task process 10 may generate a histogram illustrating performance of individuals over time and hold them accountable if their work is frequently rejected as inadequate or untimely.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, and any combinations thereof will be apparent to those of ordinary skill in the art without departing from the scope and spirit of the disclosure. The implementation(s) were chosen and described in order to best explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, and combinations thereof) are possible without departing from the scope of the disclosure defined in the appended claims.

What is claimed is:

1. A computer-implemented method comprising:
determining, at a first computing device, an occurrence of an event;
sending a task associated with the event to be completed based upon, at least in part, the occurrence of the event;
receiving information to verify that the task associated with the event is complete from a second computing device; and
identifying the task associated with the event as complete based upon, at least in part, the information.

2. The computer-implemented method of claim 1 wherein determining the occurrence of the event includes receiving a serialized data feed associated with the event.

3. The computer-implemented method of claim 1 wherein the information includes at least one of an image, a video, a voice, a text, and a numeric value.

4. The computer-implemented method of claim 1 wherein the information includes at least one of a time when the task associated with the event is complete and a location of where the task associated with the event is complete.

5. The computer-implemented method of claim 1 wherein sending the task associated with the event includes sending at least one of a description of the task and an image of the task.

6. The computer-implemented method of claim 1 wherein identifying the task associated with the event as complete includes performing comparative analysis with the information.

7. The computer-implemented method of claim 1 further comprising receiving a request to generate a visual representation of one or more previously completed tasks.

8. A computing system including a processor and a memory configured to perform operations comprising:
determining, at a first computing device, an occurrence of an event;
sending a task associated with the event to be completed based upon, at least in part, the occurrence of the event;
receiving information to verify that the task associated with the event is complete from a second computing device; and
identifying the task associated with the event as complete based upon, at least in part, the information.

9. The computing system of claim 8 wherein determining the occurrence of the event includes receiving a serialized data feed associated with the event.

10. The computing system of claim 8 wherein the information includes at least one of an image, a video, a voice, a text, and a numeric value.

11. The computing system of claim 8 wherein the information includes at least one of a time when the task associated with the event is complete and a location of where the task associated with the event is complete.

12. The computing system of claim 8 wherein sending the task associated with the event includes sending at least one of a description of the task and an image of the task.

13. The computing system of claim 8 wherein identifying the task associated with the event as complete includes performing comparative analysis with the information.

14. The computing system of claim 8 further comprising receiving a request to generate a visual representation of one or more previously completed tasks.

15. A computer program product residing on a computer readable storage medium having a plurality of instructions stored thereon which, when executed by a processor, cause the processor to perform operations comprising:
determining, at a first computing device, an occurrence of an event;
sending a task associated with the event to be completed based upon, at least in part, the occurrence of the event;
receiving information to verify that the task associated with the event is complete from a second computing device; and
identifying the task associated with the event as complete based upon, at least in part, the information.

16. The computer program product of claim 15 wherein determining the occurrence of the event includes receiving a serialized data feed associated with the event.

17. The computer program product of claim 15 wherein the information includes at least one of an image, a video, a voice, a text, and a numeric value.

18. The computer program product of claim 15 wherein the information includes at least one of a time when the task associated with the event is complete and a location of where the task associated with the event is complete.

19. The computer program product of claim 15 wherein sending the task associated with the event includes sending at least one of a description of the task and an image of the task.

20. The computer program product of claim 15 wherein identifying the task associated with the event as complete includes performing comparative analysis with the information.

21. The computer program product of claim 15 further comprising receiving a request to generate a visual representation of one or more previously completed tasks.
